(19) United States
(12) Patent Application Publication
(10) Pub. No.: US 2009/0184036 A1
(43) Pub. Date: Jul. 23, 2009

(54) FLUID FILTER FOR COMBUSTION ENGINE SYSTEMS AND METHODS

(76) Inventors: Harold R. Martin, Cookeville, TN (US); Mark T. Wleczorek, Cookeville, TN (US); Chad M. Thomas, Algood, TN (US); William C. Haberkamp, Cookeville, TN (US)

Correspondence Address: HAMRE, SCHUMANN, MUELLER & LARSON, P.C., P.O. BOX 2902, MINNEAPOLIS, MN, 55402-0902, US

(21) Appl. No.: 12/016,095

(22) Filed: Jan. 17, 2008

(51) Int. Cl. B01D 35/14

(52) U.S. Cl. 210/131

(57) ABSTRACT

Described herein are embodiments of a fluid filter for combustion engine systems and associated methods. According to one exemplary embodiment, a fluid filter apparatus for reducing re-entrainment of contaminant particles into post-filtration fluid flow due at least in part to a fluid flow surge includes at least one fluid filter and a fluid flow diverting element that is coupled to the fluid filter. The fluid filter includes at least one fluid filtering medium that is communicable in fluid flow receiving communication with a fluid flowing along a first fluid flow path during a fluid flow non-surge event. During a fluid flow surge event, the fluid flow diverting element is capable of diverting at least some of the fluid from the first fluid flow path to a second fluid flow path.

### FIELD

The present application relates to fluid filters and methods for combustion engine systems and more particularly relates to fluid filters and methods for reducing re-entrainment of contaminant particles into post-filtration fluid flow due at least in part to fluid flow surges.

### BACKGROUND

Fluid filters are used in a wide variety of applications. For example, in the automotive and general engine industry, they are used to filter fuel, coolant, oil and other lubricants, water, and other fluids, in various components of the engine. One example of a filter might be a typical cylindrical filter cartridge made of a filter medium that can be constructed of, e.g., paper, cardboard, felt, melt-spun, or other media, often a material which can be incinerated when the element is replaced to reduce waste. End plates typically constructed of plastic, are usually joined to the element.

While conventional fluid filters may be adequate to filter contaminant particles from fluid flow at a fairly constant flow rate and pressure, many conventional fluid filters exhibit shortcomings during periods of variable flow rate and pressure changes, such as is associated with flow surges and clogged or saturated filter mediums. Defined generally, flow surges include an intentional or unintentional sudden increase in the flow rate and pressure of a fluid due to any of various events, such as in response to an intentional throttle increase in an engine. Pressure increases can also occur gradually, such as when the filter medium of the fluid filter becomes saturated with contaminant particles and fluid flow through the filter medium is constricted.

Flow surges and saturated filter mediums can result in contaminant particles being dislodged from the filter mediums and re-entrained with fluid exiting the filter. Because of the highly sensitive nature of many of the systems associated with modern engine-driven applications, such as fuel systems for automobiles, unfiltered contaminant particles entering such systems can cause significant damage to or negatively affect the performance of the systems.

### SUMMARY

Based on the shortcomings of conventional fluid filters as discussed above, a need exists for an apparatus, system, and method that reduces re-entrainment of contaminant particles into post-filtration fluid flow due to fluid flow surges and/or filter medium saturation. Accordingly, described below are various embodiments of an apparatus, system, and methods that overcome one or more of the shortcomings of conventional fluid filters.

In one exemplary embodiment, a fluid filter apparatus for reducing re-entrainment of contaminant particles into post-filtration fluid flow due at least in part to a fluid flow surge includes at least one fluid filter and a fluid flow diverting element that is coupled to the fluid filter. The fluid filter includes at least one fluid filtering medium that is communicable in fluid flow receiving communication with a fluid flowing along a first fluid flow path during a fluid flow non-surge event. During a fluid flow surge event, the fluid flow diverting element is capable of diverting at least some of the fluid from the first fluid flow path to a second fluid flow path.

In some implementations, the fluid flow diverting element includes a flexible skirt capable of resiliently flexing during a fluid flow surge event to define the second fluid flow path. The flexible skirt may be substantially arcuate in some instances.

In some implementations, the at least one fluid filtering medium includes at least first and second fluid filtering media. In these implementations, the fluid flow diverting element may include a bypass valve that is intermediate the first and second fluid filtering media, and defines the second fluid flow path. The first and second fluid filtering media may include at least two substantially annular-shaped and concentric fluid filtering media. In specific implementations, the first fluid flow path includes a first fluid flow sub-path and a second fluid flow sub-path, and wherein the diverting element further comprises a flexible skirt capable of resiliently flexing during a fluid flow surge event to define the second fluid flow sub-path.

The at least one fluid filter may include at least first and second fluid filters in some instances. The fluid flow diverting element of the first fluid filter may include a flexible skirt and the fluid flow diverting element of the second fluid filter may include a bypass valve. In certain implementations, the first and second fluid filters are in series with each other. In other implementations, the first and second fluid filters are in parallel with each other.

According to another exemplary embodiment, a fluid filter apparatus includes a fluid filter and a flexible baffle element coupled to the filter. The fluid filter includes at least one fluid filtering medium that is communicable in fluid flow receiving communication with a fluid. During a fluid flow surge event, the flexible baffle element flexes to dampen the fluid flow surge. The flexible baffle element may be substantially arcuate. In certain instances, the flexible baffle element extends along substantially the entire length of the fluid filtering medium in a spaced-apart relationship with the medium.

In some implementations, the fluid filter includes a filter housing that at least partially covers the fluid filter. The fluid flow path may include a first section intermediate the flexible baffle element and the filter housing, and a second section intermediate the baffle element and the at least one fluid filtering medium.

According to yet another exemplary embodiment, a fluid filter apparatus includes a housing that has a fluid inlet and a fluid outlet. The apparatus also includes first and second fluid filtering media. The first fluid filtering medium is communicable in fluid flow receiving communication with a fluid flowing in a first fluid flow path between the fluid inlet and the first fluid filtering medium. The second fluid filtering medium is communicable in fluid flow receiving communication with fluid flowing in a second fluid flow path between the first and second filtering mediums. The second fluid filtering medium also is communicable in fluid providing communication with a third fluid flow path between the second fluid filtering medium and the fluid outlet. The fluid filter includes a bypass valve that is coupled to the first fluid flow path at a first end and the second fluid flow path at a second end. When fluid flowing through the fluid inlet has a pressure below a predetermined pressure, substantially all the fluid flows from the first fluid flow path through the first fluid filtering medium prior to flowing through the second fluid filtering medium. However, when fluid flowing through the first fluid flow path has a pressure above a predetermined pressure, the bypass valve opens to allow at least some fluid flowing through the first fluid flow path to flow directly into the second fluid flow path and through the second fluid medium without flowing through the first fluid medium.

In some implementations, the first and second fluid filtering media are substantially annular shaped with the first fluid filtering medium being concentric with the second fluid filtering medium. In certain implementations, the first fluid filtering media is less efficient than the second fluid filtering media. The bypass valve may be positioned between the first and second fluid filtering media. In some instances, the bypass valve comprises a passive bypass valve. In other instances, the bypass valve comprises an active bypass valve.

In some implementations, the fluid filter apparatus further includes a sensor that is electrically coupled to the bypass valve and a bypass valve operational state indicator. The sensor senses the operational state of the bypass valve and the bypass valve operational state indicator indicates the operational state of the bypass valve. In certain instances, the bypass valve operational state indicator is capable of indicating when the first fluid filtering medium should be replaced.

According to another embodiment, a method of filtering contaminant particles from a fluid in a combustion engine system includes providing a fluid filter apparatus with a fluid filter and a fluid flow diverting element coupled to the fluid filter. The method also includes flowing fluid at a first pressure below a predetermined pressure through the fluid filter along a first fluid flow path. Additionally, the method includes flowing fluid at a second pressure above the predetermined pressure through the fluid filter along a second fluid flow path created by engagement between the fluid at the second pressure and the fluid flow diverting element.

In some implementations, the fluid flow diverting element includes a flexible skirt member. In these implementations, engagement between the fluid at the second pressure and the flexible skirt may include applying a pressure against the flexible skirt member to flex the flexible skirt member.

In some implementations, the fluid flow diverting element includes a bypass valve. In these implementations, engagement between the fluid at the second pressure and the flexible skirt comprises applying a pressure against the bypass valve to open the bypass valve. In specific instances, the fluid filter includes a first contaminant capturing medium and a second contaminant capturing medium. Flowing fluid at the first pressure along the first fluid flow path may then include flowing fluid at the first pressure through the first and second contaminant capturing mediums, and flowing fluid at the second pressure along the second fluid flow path may then include flowing fluid around the first contaminant capturing medium, through the bypass valve and through the second contaminant capturing medium.

Reference throughout this specification to features, advantages, or similar language does not imply that all of the features and advantages that may be realized with the subject matter of the present application should be or are in any single embodiment of the application. Rather, language referring to the features and advantages is understood to mean that a specific feature, advantage, or characteristic described in connection with an embodiment is included in at least one embodiment of the present application. Thus, discussion of the features and advantages, and similar language, throughout this specification may, but do not necessarily, refer to the same embodiment.

Furthermore, the features, advantages, and characteristics of the various embodiments described herein may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments.

These features and advantages will become more fully apparent from the following description and appended claims, or may be learned by the practice of the subject matter of the application as set forth hereinafter.

### BRIEF DESCRIPTION OF THE DRAWINGS

The features and advantages of the subject matter of the present application may be more readily understood with reference to specific exemplary embodiments illustrated in the appended drawings. Understanding that these drawings depict only examples of various embodiments of the present application and are not therefore to be considered to limit the scope of the present application, certain embodiments will be described and explained with additional specificity and detail through the use of the accompanying drawings, in which:

FIG. 1 is a schematic view of a fluid delivery system coupled to a fluid source and fluid consuming device according to one embodiment;

FIG. 2a is a cross-sectional side view of a fluid filter according to one embodiment shown with a skirt member in an un-flexed state;

FIG. 2b is a cross-sectional side view of the fluid filter of FIG. 2a shown with the skirt member in a flexed state;

FIG. 3 is a perspective view of a fluid filter element of a fluid filter according to one embodiment.

FIG. 4a is a cross-sectional side view of a fluid filter according to another embodiment shown with a bypass valve in a closed position;

FIG. 4b is a cross-sectional side view of the fluid filter of FIG. 4a shown with the bypass valve in an open position; and

FIG. 5 is a cross-sectional side view of a fluid filter including a flexible skirt element and a bypass valve according to yet another embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present application. Thus, appearances of the phrases “in one embodiment,” “in an embodiment,” and similar language throughout this specification may, but do not necessarily, all refer to the same embodiment. In some instances, well-known structures, materials, or operations are not shown or described in detail to avoid obscuring aspects of the invention.

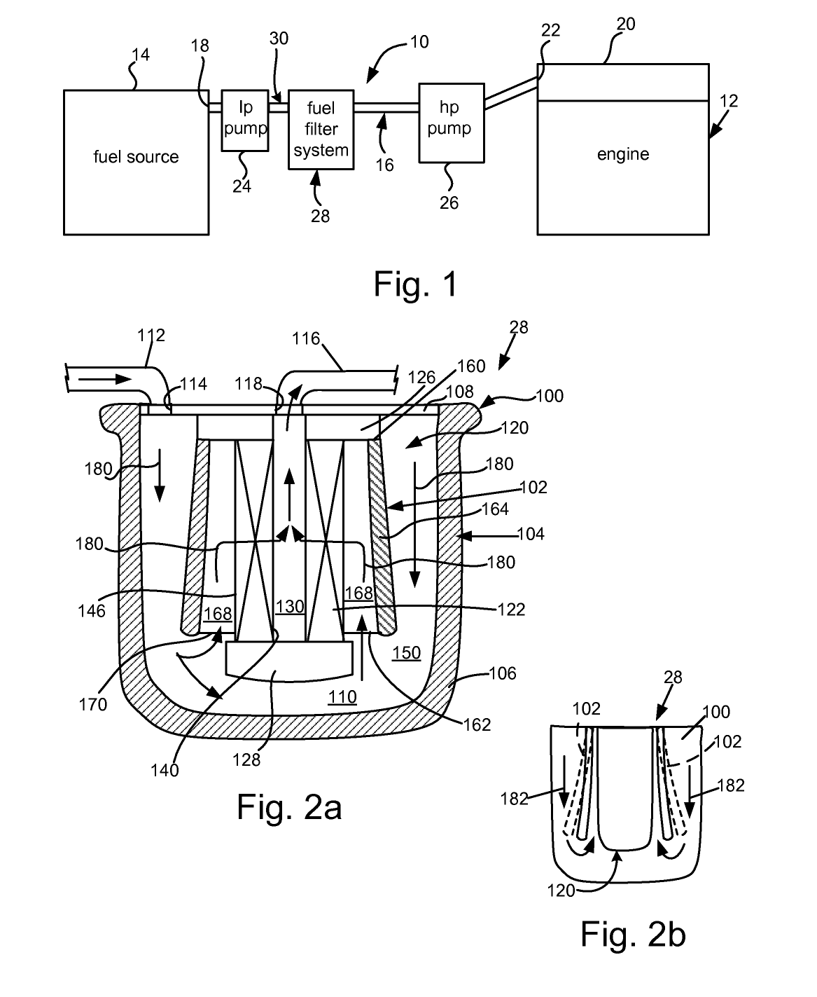

As discussed above, fluid filters are used in fluid delivery systems, such as shown in FIG. 1. Generally, a fluid delivery system is coupled to a fluid using component and delivers fluid from a source to the fluid using component. The fluid filter is configured to remove contaminant particles from fluid flow prior to the fluid being used by the fluid using component. The fluid using component can be any of various components commonly used in various industries, such as automotive, marine, industrial equipment, etc., and the fluid can be any of various fluids, such as air, hydraulic fluid, oil, water, fuel, coolant, etc. For example, in the automotive industry, an automobile can include numerous fluid using components each coupled to one or more fluid delivery systems. More specifically, in an automobile, the engine is a fluid using component typically coupled to, for example, an air delivery system, a coolant delivery system, an oil delivery system, and a fuel delivery system. Each delivery system typically requires a fluid filter to remove contaminants from the associated fluid. It is recognized that the fluid filter and associated methods described herein are not limited to any one fluid using component, or any one fluid delivery system.

For illustrative purposes only, FIG. 1 shows a fuel delivery system 10 coupling an internal combustion engine 12 to a fuel source 14. The fuel delivery system 10 includes a fuel delivery line 16 coupled to the fuel source 14 at a first end 18 and a fuel distribution system 20 at a second end 22. The fuel delivery line 16 includes first and second fuel pumps 24, 26 and a fuel filter system 28. The first fuel pump 24 can be a low pressure fuel pump positioned intermediate the first end 18 of the fuel delivery line 16 and the fuel filter system 28, and the second fuel pump 24 can be a high pressure fuel pump positioned intermediate the second end 22 of the fuel delivery line and the fuel filter system. Each component of the fuel delivery line 16 is coupled together by a fuel conduit, or hose 30.

In operation, the low pressure fuel pump 24 is operable to pump fuel from the fuel source 14, through the fuel filter system 28 and into the high pressure fuel pump 26 via the fuel hose 30. The low pressure fuel pump 24 is selectively controllable to vary the rate of fuel flow into the fuel filter system 20. Based on the fuel flow rate, the fuel exits the low pressure fuel pump 24 at a first predetermined pressure. As the fuel flows through the fuel filter system 20, the fuel filter system removes contaminant particles from the fuel. The high pressure fuel pump 26 is operable to pump fuel received from the fuel filter system 20 into the fuel distribution system 20. Like the low pressure fuel pump 24, the high pressure fuel pump 26 is selectively controllable to vary the rate of fuel flow into the fuel distribution system 20. Again, based on the fuel flow rate, the fuel exits the high pressure fuel pump at a second predetermined pressure that is typically higher than the first predetermined pressure. The fuel distribution system 30 receives the fuel at the second predetermined pressure and introduces it into the engine for combustion. In certain implementations, the fuel distribution system 30 can be a conventional fuel injection system, such as a common-rail fuel injection system. In other implementations, the fuel distribution system 30 can be a carburetor.

Although the fuel delivery system 10 illustrated in FIG. 1 includes a low pressure fuel pump 24 and a high pressure fuel pump 24, in other embodiments, for example, the system 10 can have any number of low and high pressure fuel pumps 24, 26 arranged and positioned in any number of various ways. Further, in some embodiments, the fuel delivery system 10 includes only a low pressure fuel pump 24. Also, although the low pressure fuel pump 24 is positioned intermediate the fuel source 14 and the fuel filter system 28, in some embodiments, the low pressure fuel pump 24 can be positioned within the fuel source 16. In other aspects, such as in the case of a vacuum-type pump, the low pressure fuel pump 24 can be positioned intermediate the fuel filter system 28 and the high pressure fuel pump 26. Likewise, in some embodiments, the high pressure fuel pump 26 can be positioned upstream of the fuel filter system 28, such as intermediate the fuel filter system 28 and the low pressure fuel pump 24.

Moreover, although the fuel delivery system 10 illustrated in FIG. 1 includes one fuel filter system 28 positioned intermediate the low and high pressure fuel pumps 24, 26, in other embodiments, the fuel delivery system can include any number of fuel filter systems positioned along the fuel delivery line in any number of spatial configurations relative to the fuel pump or pumps and any other fuel filter systems.

According to one embodiment illustrated in FIGS. 2a and 2b, the fuel filter system 28 includes a fuel filter 100 having a skirt member 102. The fuel filter 100 includes a filter housing 104 with a base portion 106 and lid portion 108. The base and lid portions 106, 108 define an interior chamber 110. The fuel hose 30 includes a fuel filter inlet section 112 coupled to a fuel inlet 114 formed in the filter housing 104, and a fuel filter outlet section 116 coupled to a fuel outlet 118 formed in the filter housing.

The fuel filter 100 includes a fuel filter element 120 coupled to the filter housing 104 and positioned within the interior chamber 110 of the housing. The fuel filter element 120 includes a fuel filter medium 122 attached to first and second end plates 126, 128, respectively. The fuel filter medium 122 has a generally cylindrical shape that defines a hollow generally cylindrical shaped interior space 130. The interior space 130 of the filter medium 122 is fluidly coupled to the fuel outlet 118 and outlet section 116 of the hose 30, either directly, or indirectly, such as via a hollow center post as will be discussed in more detail below. The fuel filter 100 includes a pre-filtration fluid receiving space 150 defined generally as the space within the interior space 130 and between the filter housing 104 and the filter element 120. The fuel filter media 122 can be made from conventional filter materials, such as, for example, paper, cardboard, felt, melt-spun, or other media as discussed above.

In certain instances, the fuel filter element 120 is a replaceable cartridge that is insertable into and removable from the interior chamber 110 of the filter housing 104. In such instances, the housing 104 can include a center post or stand pipe (not shown) integrally formed in or mounted to the housing. The center post extends substantially transversely relative to the lid portion 108 and includes a hollow bore extending a length of the center post. An end of the hollow bore can be coextensive with the fuel outlet. The center post can include one or more through-apertures extending through a wall of the post from an exterior of the post to the hollow bore. The end plates 126, 128 of the replaceable cartridge can include apertures concentric with the central axis of the cartridge.

The replaceable cartridge is mounted within the filter housing 104 by sliding the cartridge over the center post such that the center post extends through the apertures in the end plates of the cartridge. The fuel filter medium 122 can be sized such that the interior space 130 has a diameter that is larger than a diameter of the center post. Accordingly, when the cartridge is properly mounted within the filter housing 104, a substantially annular space is defined between an interior surface 140 of the filter medium 122 and an exterior surface of the center post. In some implementations, a sealing element, such as an o-ring, can be positioned between the apertures in the end plates of the cartridge and the center post to prevent fluid from passing between the apertures and center post.

In the illustrated embodiments, the skirt member 102 is a generally cylindrically shaped tubular member having a first fixed end 160 and a second free end 162 opposite the fixed end. The first fixed end 160 is secured to the end plate 126 and the second free end 162 terminates at a location away from the fixed end. The skirt member 102 includes a side wall 164 that extends between the first fixed end and second free end, 160, 162. The side wall 164 has a generally circular cross-sectional shape in cross-section and defines an interior space 166 within which at least a portion of the filter medium 122 is positioned. More specifically, the skirt member 102 is positioned substantially around and spaced-apart from the filter medium 122 to define a fluid passageway 168 between the side wall 164 of the skirt member and an outer surface 146 of the filter medium. The fluid passageway 168 includes an inlet opening 170 defined between the second free end 162 and the filter medium 122. In certain instances, the inlet opening 170 is generally annular shaped.

In some embodiments, the skirt member 102 has a substantially curved or arcuate shaped portion or portions, e.g., a generally bell shape, in the lengthwise or longitudinal direction. For example, in the embodiment illustrated in FIG. 2a, the side wall 164 extends substantially parallel to the outer surface 146 of the filter medium 122 from the fixed end 160 to a specific location intermediate the fixed end and free end 162. From the intermediate location to the free end 162, the side wall 164 the side wall curves outwardly away from the outer surface 146 of the filter medium 122. In other embodiments, the skirt member 102 curves outwardly away from the outer surface 146 of the filter medium 122 the entire length of the skirt member, e.g., from the fixed end 160 to the free end 162. The curved portions of the side wall 164 can have any one of various constant or variable radii of curvature. It is recognized that a curved portion can be a single continuous longitudinally curved surface or two or more straight surfaces angled with respect to each other that collectively define a curved portion.

In some embodiments, the side wall 164 can be substantially straight. For example, the side wall 164 can extend substantially parallel to the outer surface 146 of the filter medium 122 from the fixed end 160 to the free end 162. Alternatively, the side wall 164 can form a constant angle with the outer surface 146 of the filter medium 122 along the length of the side wall.

Preferably, the skirt element 102 is movable away from and toward the filter medium 122. For example, the skirt element 102 can be made from any of various resiliently flexible materials, such as, but not limited to, plastic and rubber. The skirt element 102 can bend or flex from an unflexed position (e.g., as shown in dashed lines in FIG. 2b) to a flexed position (e.g., as shown in solid lines in FIG. 2b). In other words, the skirt element 102 moves toward the skirt element 102 as it bends or flexes. The skirt element 102 is configured to flex or bend when impacted with a predetermined force sufficient to overcome the designed bias of the skirt element. The bias of the skirt element 102 is based at least partially on the material for and shape, e.g., thickness, of the sidewall 164. For example, the bias of the skirt decreases as the thickness of the skirt decreases. In certain implementations, the sidewall 164 is corrugated to facilitate flexing and resilient deformation.

In addition to, or in place of, forming the skirt out of a resiliently flexible material, the filter element 120 can include a hinged portion (not shown) coupling the skirt element 102 to the top plate 126. The hinged portion can be configured to allow the skirt element 102 to pivot about the hinged portion to move the filter element 120 toward the filter medium 122. The hinged portion can be biased to allow the skirt element to pivot only upon receiving a force at or above a predetermined force.

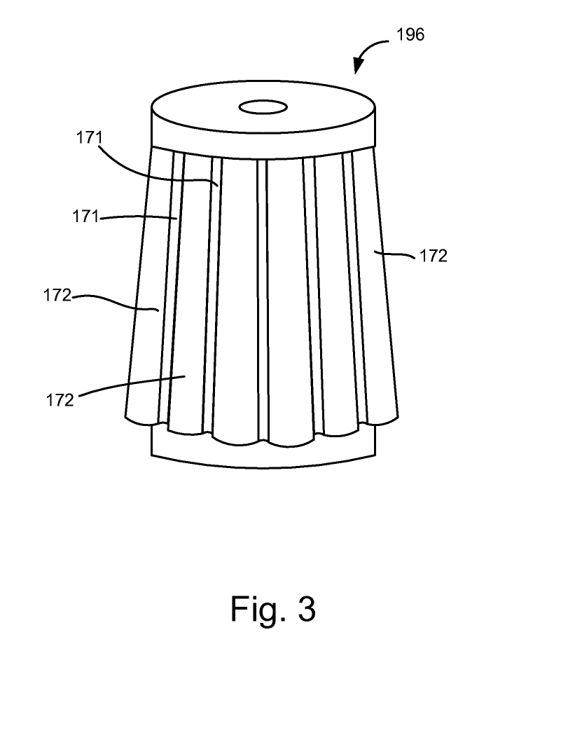

Referring to FIG. 3, in some embodiments, the skirt element, such as skirt element 196, includes a plurality of expansion joints 171 extending longitudinally along the skirt element 102 between adjacent sidewall sections 172. The expansion joints 171 are configured to deform to allow the sidewall sections 172 to move toward and away from each other as the side wall 164 moves toward and away from the filter medium 122. The expansion joints 171 can be made of a material, e.g., rubber, that is more flexible than the material of the sidewall sections 172, e.g., plastic.

Generally, the fuel filter 100 operates to move the skirt element 102 in response to a fluid surge event to mitigate the possible negative effects of the surge event. More specifically, fuel pumped from the fuel tank 14 flows through fuel filter inlet section 112 of the hose 30 and into the filter housing 104 via the fuel inlet 114. The fuel entering the filter housing 104 occupies and at least partially flows through the pre-filtration fluid receiving space 150. From the pre-filtration fluid receiving space 150 the fluid flows through the inlet opening 170, into the passageway 168, through the filter medium 122, into the interior space 130, and out of the filter 100 via the fuel outlet 118.

During non-surge events, i.e., when the fuel entering the filter housing 104 is below a predetermined pressure threshold and the flow rate differential is substantially zero, the fluid flowing into the filter 100 and passed the skirt element 102 does not impact the skirt element with sufficient force to overcome the bias of the skirt element. Accordingly, the fluid flows through the filter 100 along a first fluid flow path 180 defined by the skirt element 102 in the unflexed state (see FIG. 2a). The first fluid flow path 180 includes the inlet area defined by the inlet opening 170.

During surge events, when the fuel entering the filter housing 204 is above a predetermined pressure threshold and the flow rate differential is greater than a predetermined amount, such as zero, the fluid entering the filter 100 impact the skirt element 102 and causes it to flex inwardly toward the filter medium 122. Accordingly, the fluid flows through the filter 100 along a second fluid flow path 182 defined by the skirt element 102 in the flexed state (see FIG. 2b). The second fluid flow path 182 includes the inlet area defined by the inlet opening 170, which is smaller than the inlet area of the first fluid flow path 180 because the free end 162 of the skirt element 102 is closer to the filter medium 122.

As discussed above, the additional flow of fluid during surge events often impacts the filter medium and causes captured contaminate particles to dislodge and re-entrain with the fluid. The skirt element 102 reduces this effect by absorbing the impact of the additional fluid flow before it impacts the filter medium 122. Additionally, because the fluid entering the filter must travel the length of the skirt element 102 before entering the filter medium 122, the skirt element 102 acts as a baffle element to redistribute the additional flow surge, thus promoting more uniform fluid flow into the filter medium

Although the illustrated embodiments include a movable skirt member, the skirt member need not be movable to realize at least some of the advantages of the disclosed fluid filter. For example, fluid must still travel the length of the skirt element before entering the filter medium 122. Therefore, flow surges are redistributed to promote uniform fluid flow into the filter medium in the same manner as the movable skirt member 102.

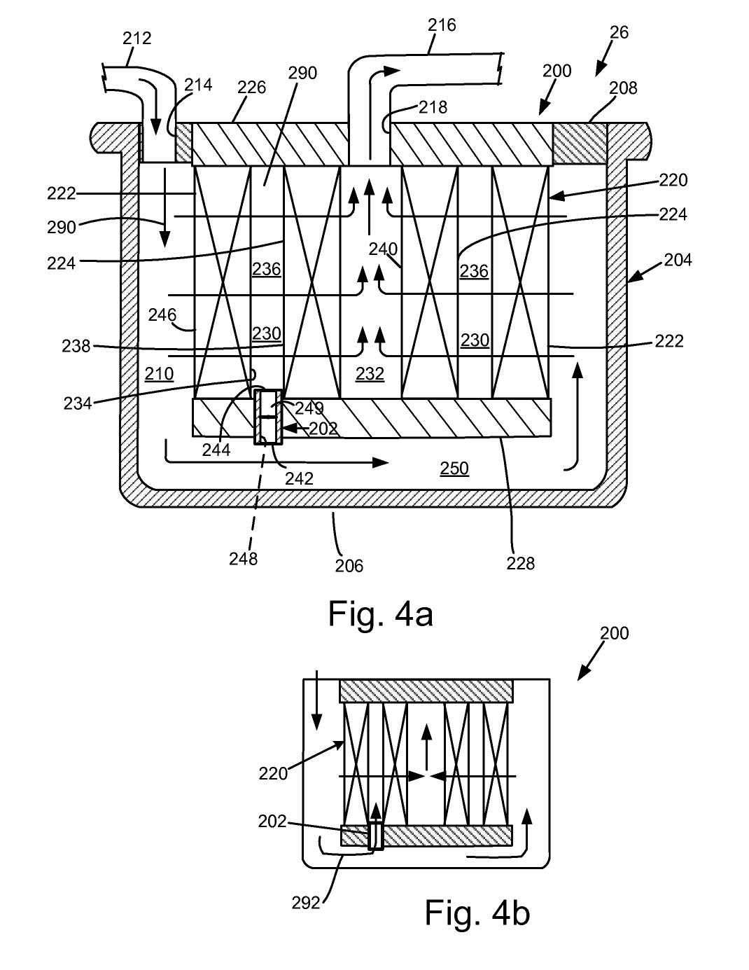

According to a second embodiment illustrated in FIGS. 4a and 4b, the fuel filter system 28 is a fuel filter 200 having a bypass valve 202. The fuel filter 200 also includes a filter housing 204 that includes a base portion 206 and a lid portion 208. The base and lid portions 206, 208 define an interior chamber 210. The fuel hose 30 includes a fuel filter inlet section 212 coupled to a fuel inlet 214 formed in the filter housing 204, and a fuel filter outlet section 216 coupled to a fuel outlet 218 formed in the filter housing.

The fuel filter 200 includes a fuel filter element 220 coupled to the filter housing 204 and positioned within the interior chamber 210. The fuel filter element 220 includes a first and second fuel filter media 222, 224 intermediate and attached to first and second end plates 226, 228, respectively. The first and second fuel filter media 222, 224 each have a generally cylindrical shape that defines a respective hollow cylindrically shaped interior space 230. As discussed above, the first and second fuel filter media 222, 224 can be made from conventional filter materials, such as, for example, paper, cardboard, felt, melt-spun, or other media.

The second fuel filter media 224 is positioned within the interior space 230 of the first fuel filter media 222 such that the first and second fuel filter media are concentric, i.e., share a common central axis. Moreover, the first and second fuel filter media 222, 224 are sized such that a generally elongate annular space 236 is defined between an inner surface 234 of the first fuel filter media and an outer surface 238 of the second fuel filter media. The interior space 232 of the second filter medium 224 is fluidly coupled to the fuel outlet 218, either directly, or indirectly, such as via a hollow center post as will be discussed in more detail below. The fuel filter 200 includes a pre-filtration fluid receiving space 250 defined generally as the space between the filter housing 204 and an outer surface 246 of the first filter medium 22 and the second end plate 228.

In certain instances, the fuel filter element 220 is a replaceable cartridge that is insertable into and removable from the interior chamber 210 of the filter housing 204 in a manner similar to that described above in relation to fuel filter element 120. For example, the replaceable cartridge is mounted within the filter housing 206 by sliding the cartridge over the center post such that the center post extends through the apertures in the end plates of the cartridge. The second fuel filter medium 224 can be sized such that the interior space 232 has a diameter that is larger than a diameter of the center post. Accordingly, when the cartridge is properly mounted within the filter housing 206, a substantially annular space is defined between an interior surface 240 of the second fuel filter medium 224 and an exterior surface of the center post.

The bypass valve 202 can be any of various pressure relief valves known in the art, such as, for example, compressor bypass valves, blow-off valves, dump valves, vent valves, and the like. Referring to FIGS. 4a and 4b, the bypass valve 202 includes an inlet end 242 and outlet end 244. The inlet and outlet ends 242, 244 are coupled together by a fluid passageway 248 extending between the inlets and outlet ends. The bypass valve 202 includes a passageway blocking element 249, such as a piston, cover, partition, and the like, that is movable between closed and open positions. In the closed position, the blocking element 249 is situated within and completely obstructs the fluid passageway to prevent fluid from passing from the inlet end to the outlet end. In the open position, the blocking element is at least partially removed from or moved relative to the fluid passageway to allow at least some fluid to pass from the inlet end 242 to the outlet end 244.

The bypass valve 202 is configured to open and allow fluid to flow between the inlet and outlet ends in response to a fluid having a pressure higher than a predetermined pressure. In contrast, the bypass valve 202 remains closed and prevents fluid from flowing between the inlet and outlets ends 242, 244 in response to a fluid having a pressure above a predetermined pressure. The bypass valve 202 can be a passive-type or active-type valve. For example, with passive-type valves, the passageway blocking element is biased in the closed position by a biasing element, such as a spring. The biasing element has a predetermined biasing constant, such as a spring constant, associated with a predetermined fluidic pressure. Once a fluid in contact with the blocking element reaches the predetermined fluidic pressure, the force of the fluid acting on the blocking element overcomes the biasing force of the biasing element and the blocking element 249 is at least partially moved from out of the fluid passageway to allow at least some fluid to flow through the passageway 248 between the inlet and outlet ends 242, 244. With active-type valves, electronic sensors can be used to determine the pressure of a fluid and electronically communicate with the valve via a computing device, such as an ECU, to open the valve in the event a predetermined pressure is reached.

The bypass valve 202 is positioned such that the inlet end 242 is open to the pre-filtration fluid receiving space 250 and the outlet end 244 is open to the elongate annular space 236. In the illustrated embodiment, bypass valve 202 is secured to the end plate 224 and held in place between the pre-filtration fluid receiving space 250 and the elongate annular space 236. Although the bypass valve 202 in the illustrated embodiment is secured to the end plate 228 and positioned adjacent the first and second fuel filter media 222, 224, in other embodiments, the bypass valve can be secured to other portions of the filter housing and positioned away from the fuel filter media. For example, in certain aspects, the bypass valve 202 can be positioned outside of the housing with the inlet end 242 fluidly coupled to the pre-filtration fluid receiving space via a conduit, such as a tube or hose, and the outlet end 244 fluidly coupled to the elongate annular space 236 via a similar conduit.

Generally, the fuel filter 200 operates to open the bypass valve 202 to redirect a portion of fluid during a fluid flow surge event or when contaminants accumulated on the first fuel filter medium 222 reach a predetermined level. More specifically, fuel pumped from the fuel tank 14 flows through fuel filter inlet section 212 of the hose 30 and into the filter housing 204 via the fuel inlet 214. The fuel entering the filter housing 204 occupies and at least partially flows through the pre-filtration fluid receiving space 250.

During non-surge events, all fuel circulating through the pre-filtration fluid receiving space 250 follows a first fluid flow path 290 through the fuel filter element 220. Referring to FIG. 4a, the first fluid flow path 290 is defined as a fluid path extending from the pre-filtration fluid receiving space 250, through the first fuel filter medium 222, through the elongate annular space 236 between the first and second fuel filter media, through the second fuel filter medium 224, and into the interior space 232 of the second filter medium.

During surge events, the bypass valve 202 opens and some fuel occupying the pre-filtration fluid receiving space 250 follows a second fluid flow path 292 through the fuel filter element 220. Referring to FIG. 4b, the second fluid flow path 292 is defined as a fluid path extending from the pre-filtration fluid receiving space 250, through the bypass valve 202, through the elongate annular space 236 between the first and second fuel filter medium, through the second fuel filter medium 224, and into the interior space 232 of the second filter medium.

As used herein, a surge event occurs anytime the pressure within the pre-filtration fluid receiving space 250 reaches or exceeds the predetermined pressure or the fluid flow into the filter is increased by a predetermined amount. As described above, this can occur by either intentionally or unintentionally increasing the fluid flow into the filter. The pressure within the pre-filtration fluid receiving space 250 can also exceed the predetermined pressure when the fuel filter element 220 is sufficiently saturated with particulate matter that fluid is restricted from flowing through the filter element and a back pressure is created within the pre-filtration fluid receiving space. The back pressure can cause the overall pressure of the fluid within the pre-filtration fluid receiving space 250 to increase and exceed the predetermined pressure. The bypass valve 202 would then open to relieve the pressure build-up. In some implementations, a valve condition indicator can be electrically coupled to the valve and configured to provide a visual indication of the status of the valve. For example, during a surge event, the valve condition indicator can provide a visual indication, such as a light, to a user to inform the user that the valve is open and fluid is being relieved through the bypass valve. If the bypass condition indicator remains on for an extended period of time, it would indicate to a user that the filter element is saturated with contaminate particles and requires replacement. Accordingly, the valve condition indicator can act as a filter element replacement indicator.

During surge and non-surge events, fluid entering the interior space 232 flows through the fuel outlet 218 and exits the fuel filter 200 via the fuel filter outlet section 216 of the fuel hose 30. In implementations using a center post for mounting a filter cartridge in the housing 204, fluid flows from the interior space 232 and into the hollow passageway defined by the center post via the apertures formed in the center post. The fluid in the hollow passageway then exits the filter 200 through the fuel outlet 218.

During non-surge events, the first and second fuel filter media 222, 224 act in tandem to efficiently filter targeted, e.g., potentially harmful, contaminant particles from fluid flowing along the first fluid flow path. The first fuel filter medium 222 has a first contaminant-capturing efficiency and the second fuel filter medium 224 has a second contaminant-capturing efficiency. Preferably, the first efficiency is less than the second efficiency. In other words, in certain embodiments, the second fuel filter medium 224 is a more efficient filter medium than the first fuel filter medium 222. During non-surge events, the first fuel filter medium 222 captures, i.e., filters out, contaminant particles of a predetermined size contained in the fluid flowing through the first filter medium. Contaminant particles in the fluid that are smaller than the predetermined size are allowed to pass through the first filter medium 222, but are captured by the second filter medium. Accordingly, fluid exiting the second filter medium is substantially free of the contaminant particles targeted by the first and second filter media 222, 224.

Fuel surges can disrupt the efficiency of the fuel filter 202. The relatively large contaminant particles filtered out of the fluid by the first filter medium 222 build up on the first filter medium and the relatively small contaminant particles filtered out of the fluid by the second filter medium 224 build up on the second filter medium. During a surge event, the increased pressure or pressure differential results in fluid at a higher pressure flowing through the first filter medium 222. The higher pressure can be any pressure above a predetermined pressure specific to the engine system specifications. The high pressure fluid has a tendency to dislodge contaminant particles caked on the first filter medium 222. The dislodged contaminant particles then re-entrain with fluid exiting the first filter medium. Often, the high pressure fluid also forces or propels the dislodged contaminant particles through the second fuel filter medium 224 or dislodges contaminant particles captured by the second fuel filter medium 224. In other words, because of the flow surge, the relatively high efficiency second fuel filter medium 224 is unable to capture contaminant particles dislodged from the first fuel filter medium 222 or contaminant particles are dislodged from the second filter medium such that contaminant particles re-entrain with fluid exiting the second filter medium. The dislodged contaminant particles are then carried to the fuel injectors and engine where they can damage or cause significant wear on various components of an engine system, such as the fuel injectors, fluid pump and the engine itself.

During fuel surge events, the bypass valve 202 opens to reduce re-entrainment of contaminant particles into fluid passing through the filter media 222, 224. As the bypass valve 202 opens, some fluid in the pre-filtration fluid receiving space is allowed to flow through the valve along the second fluid flow path. This reduces the overall pressure of the fluid in the pre-filtration fluid receiving space to pre-surge event levels. Accordingly, the fluid flowing through the first fuel filter medium 222 is less likely to dislodge contaminant particles captured by the first and second filter media during a fuel surge event.

As discussed above, the bypass valve 202 can be a passive valve that opens in response to fluid in the pre-filtration fluid above the predetermined pressure contacting the valve to physically overcome the bias of the valve. Alternatively, the bypass valve 202 can be an active valve in electronic communication with an engine control unit (ECU). In anticipation of or during a surge event, the ECU can send a signal to the active bypass valve 202 to open and allow fluid to flow along the second fluid flow path.

Although the fuel filter in the illustrated embodiment of FIGS. 4a and 4b includes dual concentric filter media and a single bypass valve intermediate the dual media, in other embodiments, the fuel filter can have more than two concentric filter media and one or more bypass valves intermediate one or more pairs of filter media. In implementations having more than two filter media and more than one bypass valve, each of the filter media can have a different efficiency rating and each of the bypass valves can be configured to open in response to a different predetermined pressure.

For example, in one embodiment, the fuel filter can include first filter medium, a second filter medium concentric with and within the first filter medium, and a third filter medium concentric with and within the second filter medium. The first filter medium can have a first efficiency, the second filter medium can have a second efficiency higher than the first efficiency, and the third filter medium can have a third efficiency higher than the second efficiency. The fuel filter according to this embodiment can have a first bypass valve intermediate the first and second fuel filter media, and a second bypass valve intermediate the second and third fuel filter media. The first bypass valve can be configured to open in response to fluid at a first predetermined pressure, and the second bypass valve can be configured to open in response to fluid at a second predetermined pressure higher than the first predetermined pressure. Such a configuration allows for more precise control of the fuel filtration process and a more efficient fuel filter.

Moreover, although the fuel filter in the illustrated embodiment of FIGS. 4a and 4b includes concentric filter media, e.g., filter-in-filter configuration, in other embodiments, the filter media can be spatially positioned in other configurations relative to each other. For example, the fuel filter media can be in a side-by-side or end-to-end configuration. In some implementations, fluid can flow between the filter media via conduits, such as the hose 30. The bypass valves can be positioned in any of various positions intermediate the filter media, such as within a conduit fluidly coupling the filter media.

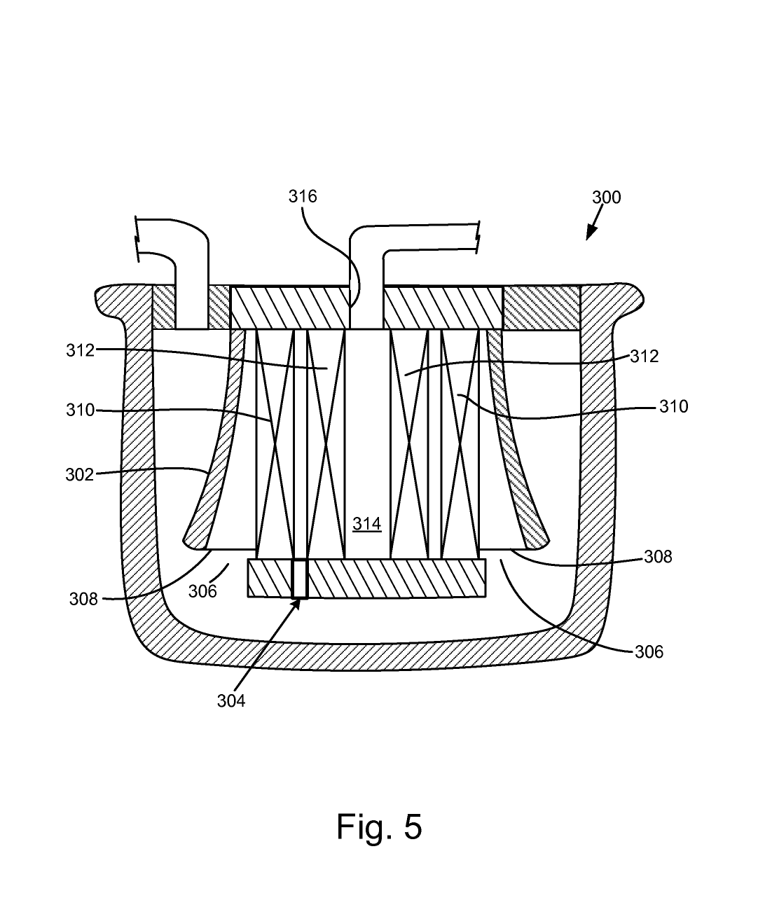

Referring now to FIG. 5, and according to a third embodiment, the fuel filter system 28 is a fuel filter 300 having a skirt element 302 similar to skirt element 102 and a bypass valve 304 similar to bypass valve 202. The skirt element 302 and bypass valve 302 cooperatively work together to provide further controllability of fluid flow through the filter 300 to mitigate the effects of fluid flow surge events.

For example, in one implementation, during a surge event, fluid entering the filter system fuel filter 300 contacts the skirt element 302. The skirt element 302 flexes to absorb the force of the surge flow. The fluid then flows through the inlet 306 defined between the free end 308 of the skirt element 302 and the first outer filter medium 310. From the inlet 306, the fluid flows through the first outer filter medium 310, the second inner filter medium 312, into the interior cavity 314, and out of the filter 300 via the fuel outlet 316. If the pressure increase from the surge event is sufficient, the pressure within the filter 300 may exceed the predetermined pressure of the bypass valve 304 and, in addition to flexing the skirt element 302, cause the bypass valve to open. With the bypass valve 304 open, at least some of the fluid flows through the valve and into the second inner filter medium 312, thus bypassing the first outer filter medium 310.

It is also recognized that in some instances, the fluid flow surge may be high enough to cause the free end 308 of the skirt element 302 to move into contact with the first outer filter medium 310 to effectively close the fluid inlet 306. With the fluid inlet 306 closed, back pressure causes the pressure within the filter 300 to increase. The increase in pressure causes the bypass valve 304 to open to relieve the pressure in the filter by redirecting, at least momentarily, all the fluid through the bypass valve and into the second inner filter medium 312. The redirection of fluid results in a drop in the overall pressure within the filter 300. Because of the pressure drop, the skirt element 302 at least partially un-flexes and moves away from the first outer filter medium 310 to re-open the fluid inlet 306 and allow fluid to once again flow through the first outer filter medium 310.

As discussed above, the fuel filter and associated methods described herein are not limited to automobile engines or fuel delivery systems. For example, in some embodiments, the fuel source 16 can be replaced by another type of fluid source, the fuel filter system 26 can be replaced by another fluid filter system adapted to filter out contaminant particles from fluids other than fuel, the pumps 22, 24 can be replaced by one or more pumps adapted to pump a fluid other than fuel, and the engine 12 can be replaced by another fluid using component.

In view of the many possible embodiments to which the principles of the disclosed fluid filter may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A fluid filter apparatus for reducing re-entrainment of contaminant particles into post-filtration fluid flow due at least in part to a fluid flow surge, comprising:
at least one fluid filter comprising at least one fluid filtering medium communicable in fluid flow receiving communication with a fluid flowing along a first fluid flow path during a fluid flow non-surge event; and
a fluid flow diverting element coupled to the fluid filter;
wherein during a fluid flow surge event, the fluid flow diverting element is capable of diverting at least some of the fluid from the first fluid flow path to a second fluid flow path.

2. The fluid filter apparatus of claim 1, wherein the fluid flow diverting element comprises a flexible skirt capable of resiliently flexing during a fluid flow surge event to define the second fluid flow path.

3. The fluid filter apparatus of claim 2, wherein the flexible skirt is substantially arcuate.

4. The fluid filter apparatus of claim 1, wherein the at least one fluid filtering medium comprises at least first and second fluid filtering media, and wherein the fluid flow diverting element comprises a bypass valve intermediate the first and second fluid filtering media, and wherein the bypass valve defines the second fluid flow path.

5. The fluid filter apparatus of claim 4, wherein the at least first and second fluid filtering media comprise at least two substantially annular-shaped concentric fluid filtering media.

6. The fluid filter apparatus of claim 1, wherein:
the at least one fluid filter comprises at least first and second fluid filters, wherein the fluid flow diverting element of the first fluid filter comprises a flexible skirt and the fluid flow diverting element of the second fluid filter comprises a bypass valve.

7. The fluid filter apparatus of claim 6, wherein the first and second fluid filters are in series with each other.

8. The fluid filter apparatus of claim 6, wherein the first and second fluid filters are in parallel with each other.

9. The fluid filter apparatus of claim 4, wherein the first fluid flow path comprises a first fluid flow sub-path and a second fluid flow sub-path, and wherein the diverting element further comprises a flexible skirt capable of resiliently flexing during a fluid flow surge event to define the second fluid flow sub-path.

10. A fluid filter apparatus, comprising:
a fluid filter comprising at least one fluid filtering medium communicable in fluid flow receiving communication with a fluid; and
a flexible baffle element coupled to the fluid filter;
wherein during a fluid flow surge event, the flexible baffle element flexes to dampen the fluid flow surge.

11. The fluid filter apparatus of claim 10, further comprising a filter housing at least partially covering the fluid filter, wherein a fluid flow path comprises a first section intermediate the flexible baffle element and the filter housing and a second section intermediate the baffle element and the at least one fluid filtering medium.

12. The fluid filter apparatus of claim 10, wherein the flexible baffle element is substantially arcuate.

13. The fluid filter apparatus of claim 10, wherein the fluid filtering medium comprises a length, and wherein the flexible baffle element extends along substantially the entire length of the fluid filtering medium in a spaced-apart relationship with the medium.

14. A fluid filter apparatus, comprising:
a housing comprising a fluid inlet and a fluid outlet;
a first fluid filtering medium communicable in fluid flow receiving communication with a fluid flowing in a first fluid flow path between the fluid inlet and the first fluid filtering medium;
a second fluid filtering medium communicable in (i) fluid flow receiving communication with fluid flowing in a second fluid flow path between the first and second filtering mediums and (ii) fluid providing communication with a third fluid flow path between the second fluid filtering medium and the fluid outlet; and
a bypass valve coupled to the first fluid flow path at a first end and the second fluid flow path at a second end;
wherein when fluid flowing through the fluid inlet has a pressure below a predetermined pressure, substantially all the fluid flows from the first fluid flow path through the first fluid filtering medium prior to flowing through the second fluid filtering medium, and
wherein when fluid flowing through the first fluid flow path has a pressure above a predetermined pressure, the bypass valve opens to allow at least some fluid flowing through the first fluid flow path to flow directly into the second fluid flow path and through the second fluid medium without flowing through the first fluid medium.

15. The fluid filter apparatus of claim 14, wherein the first and second fluid filtering media are substantially annular shaped, and wherein the first fluid filtering medium is concentric with the second fluid filtering medium.

16. The fluid filter apparatus of claim 15, wherein the bypass valve is positioned between the first and second fluid filtering media.

17. The fluid filter apparatus of claim 14, wherein the first fluid filtering media is less efficient than the second fluid filtering media.

18. The fluid filter apparatus of claim 14, further comprising a sensor electrically coupled to the bypass valve and a bypass valve operational state indicator, wherein the sensor senses the operational state of the bypass valve and the bypass valve operational state indicator indicates the operational state of the bypass valve.

19. The fluid filter apparatus of claim 18, wherein the bypass valve operational state indicator is capable of indicating when the first fluid filtering medium should be replaced.

20. The fluid filter apparatus of claim 14, wherein the bypass valve comprises a passive bypass valve.

21. The fluid filter apparatus of claim 14, wherein the bypass valve comprises a selectively controllable active bypass valve.

22. A method of filtering contaminant particles from a fluid in a combustion engine system, comprising:
providing a fluid filter apparatus comprising a fluid filter and a fluid flow diverting element coupled to the fluid filter;
flowing fluid at a first pressure below a predetermined pressure through the fluid filter along a first fluid flow path; and
flowing fluid at a second pressure above the predetermined pressure through the fluid filter along a second fluid flow path created by engagement between the fluid at the second pressure and the fluid flow diverting element.

23. The method of claim 22, wherein the fluid flow diverting element comprises a flexible skirt member and engagement between the fluid at the second pressure and the flexible skirt comprises applying a pressure against the flexible skirt member to flex the flexible skirt member.

24. The method of claim 22, wherein the fluid flow diverting element comprises a bypass valve and engagement between the fluid at the second pressure and the flexible skirt comprises applying a pressure against the bypass valve to open the bypass valve.

25. The method of claim 24, wherein the fluid filter comprises a first contaminant capturing medium and a second contaminant capturing medium, and wherein flowing fluid at the first pressure along the first fluid flow path comprises flowing fluid at the first pressure through the first and second contaminant capturing mediums, and flowing fluid at the second pressure along the second fluid flow path comprises flowing fluid around the first contaminant capturing medium, through the bypass valve and through the second contaminant capturing medium.
